(19) United States
(12) Patent Application Publication
(10) Pub. No.: US 2026/0175724 A1
(43) Pub. Date: Jun. 25, 2026

(54) CHARGING DEVICE AND LIQUID COOLED CABLE ASSEMBLY

(71) Applicant: WALSIN LIHWA CORPORATION, Taipei (TW)

(72) Inventors: Shih-Hsiang Wang, Taipei (TW); Yi-Fan Ku, Taipei (TW); Duan-Yih Lin, Taipei (TW); Cheng-Hong Chen, Taipei (TW); Shih-Wei Wang, Taipei (TW)

(21) Appl. No.: 19/169,982

(22) Filed: Apr. 3, 2025

(30) Foreign Application Priority Data
Dec. 25, 2024 (TW) 113150763

(51) Int. Cl. B60L 53/302; B60L 53/16; B60L 53/18; H01B 7/42; H01R 13/52

(52) U.S. Cl. CPC B60L 53/302; B60L 53/16; B60L 53/18; H01B 7/425; H01R 13/5202

(57) ABSTRACT

A charging device and liquid cooled cable assembly. The liquid cooled cable assembly includes a liquid cooled cable and a charging gun. The liquid cooled cable includes a first insulating tube, a second insulating tube, a taping, a line body, and a covering body. The first insulating tube has a first channel. The second insulating tube includes an insulating layer, a second channel, a power conductor, and a spacer. The spacer is disposed around the power conductor. The taping wraps the first insulating tube and the second insulating tube. The line body is located inside the taping. The covering body wraps the taping. The charging gun includes a gun connector. The gun connector includes a first water jacket, a first connector portion, a first sleeve portion, and a first terminal portion. The first water jacket includes a first communication space, a second communication space, and a gun connected channel.

### CROSS-REFERENCE TO RELATED APPLICATION

This non-provisional application claims priority under 35 U.S.C. § 119(a) to Patent Application No. 113150763 filed in Taiwan, R.O.C. on Dec. 25, 2024, the entire contents of which are hereby incorporated by reference.

### BACKGROUND

### Technical Field

The present invention relates to a liquid cooled cable assembly and a charging device, and particularly relates to a liquid cooling type liquid cooled cable assembly and a charging device.

### Related Art

In modern society, with the development of civilization, more and more products need to be charged, and with the advancement of science and technology, electric vehicles has gradually replaced gasoline vehicles. However, in related technology, most electric vehicles need to be charged through charging piles. In the process of inserting a charging gun into the electric vehicle for charging, the whole device is prone to overheating and thereby danger is caused. Especially in a cable and its connected end, it is particularly easy to overheat in the charging process, and the connected end of the charging gun may be worn out due to repeated use, and as a result, the charging efficiency is reduced and the risk of overheating is caused, it is needed to be replaced. Some of high-voltage fast charging gun products on the market at present are detachably designed as spiral between the cable/charging gun and the connected end, such design will cause the risk of overheating in a contact surface.

### SUMMARY

In view of this, according to some embodiments, a liquid cooled cable assembly is provided and includes a liquid cooled cable and a charging gun. The liquid cooled cable has a gun end and a pile end, and includes a first insulating tube, a second insulating tube, a taping, a line body and a covering body. The first insulating tube has a first channel. The second insulating tube includes an insulating layer, a second channel, a power conductor, and a spacer. The second channel is located in the insulating layer. The power conductor is located in the second channel. The spacer is disposed around the power conductor to space the power conductor from the insulating layer. The taping wraps the first insulating tube and the second insulating tube. The line body is located inside the taping and filled between the first insulating tube and the second insulating tube. The covering body wraps the taping. The charging gun includes a gun connector connected to the gun end, and the gun connector includes a first water jacket, a first connector portion, a first sleeve portion, and a first terminal portion. The first water jacket includes a first communication space, a second communication space, and a gun connected channel, and the gun connected channel connects the first communication space with the second communication space. The first connector portion is connected to the first water jacket to communicates with the first communication space, where the first insulating tube sleeves the first connector portion to enable the first channel to communicate with the first communication space. The first sleeve portion is connected to the first water jacket to communicate with the second communication space. The first terminal portion is connected to the first water jacket, where the second insulating tube sleeves the first sleeve portion, and the power conductor is electrically connected to the first terminal portion.

In some embodiments, the gun connected channel is obliquely connected to the first communication space and the second communication space at an oblique angle.

In some embodiments, the gun connector further includes a first sealing piece, the gun connected channel further includes a first opening, and the first opening is sealed through the first sealing piece.

In some embodiments, the gun connector further includes a first waterproof ring pad which is disposed between joined parts of the first connector portion and the first water jacket.

In some embodiments, the gun connector further includes a first C-shaped retaining ring and a first waterproof ring, the first C-shaped retaining ring is crimped to the first terminal portion and the power conductor, the first waterproof ring sleeves the first terminal portion, and an outer side of the first waterproof ring makes contact with the first water jacket.

In some embodiments, the gun connector further includes a first backing ring and two second waterproof rings, where the first sleeve portion further includes a first flange, one of the second waterproof rings sleeves the first sleeve portion to abut against the first flange, the insulating layer sleeves the first sleeve portion and one of the second waterproof rings, and the first backing ring and the other second waterproof ring sleeve the first sleeve portion and are located outside the insulating layer.

In some embodiments, the first water jacket further includes a first upper top surface and a first lower bottom surface, the first water jacket is tapered from the first lower bottom surface to the first upper top surface, and the first upper top surface and the first lower bottom surface are arc-shaped.

In some embodiments, the second communication space is larger than the first communication space.

In some embodiments, the gun connector further includes a first replacement cap which is detachably disposed on the first terminal portion.

In some embodiments, the spacer is made of an insulating material, and the heat deflection temperature of the spacer is higher than that of the insulating layer.

In some embodiments, a lay of the spacer ranges from 15 mm to 25 mm.

In some embodiments, the power conductor has an outer diameter R₁, the spacer has an outer diameter R₂, the second insulating tube has an inner diameter R₄, and R₁, R₂ and R₄ meet a relational expression R₄−(R₁+2R₂)/0.5−0.8.

In some embodiments, the power conductor has an outer diameter R₁, the spacer has an outer diameter R₂, the second insulating tube has an inner diameter R₄, and R₁, R₂ and R₄ meet a relational expression (R₄²−R₁²−R₂²)π/4=70−100.

According to some embodiments, a charging device is further provided and includes a liquid cooled cable assembly, a charging pile, a communication tube, and a pile connector. The liquid cooled cable assembly is described as above. The charging pile includes a cooling module and a charging module. The cooling module includes a water outlet and a water inlet, and the water inlet is connected to a pile end of the liquid cooled cable and communicated with a first channel. The charging module is electrically connected to the cooling module. One end of the communication tube is connected to the water outlet. The pile connector is electrically connected to the charging module, and includes a second water jacket, a second connector portion, a second sleeve portion, and a second terminal portion. The second water jacket includes a third communication space, a fourth communication space, and a pile connected channel, and the pile connected channel is communicated with the third communication space with the fourth communication space. The second connector portion is connected to the second water jacket to communicate with the third communication space, where the other end of the communication tube sleeves the second connector portion. The second sleeve portion is connected to the second water jacket to communicate with the fourth communication space. The second terminal portion is connected to the second water jacket, where the second insulating tube sleeves the second sleeve portion, and the power conductor is electrically connected to the second terminal portion.

In some embodiments, the pile connected channel is obliquely connected to the third communication space and the fourth communication space at an oblique angle.

In some embodiments, the pile connector further includes a second sealing piece, the pile connected channel further includes a second opening, and the second opening is sealed through the second sealing piece.

In some embodiments, the pile connector further includes a second waterproof ring pad which is disposed between joined parts of the second connector portion and the second water jacket.

In some embodiments, the pile connector further includes a second C-shaped retaining ring and a third waterproof ring, the second C-shaped retaining ring is crimped to the second terminal portion and the power conductor, the third waterproof ring sleeves the second terminal portion, and an outer side of the third waterproof ring makes contact with the second water jacket.

In some embodiments, the pile connector further includes a second backing ring and two fourth waterproof rings, the second sleeve portion further includes a second flange, one of the fourth waterproof rings sleeves the second sleeve portion to abut against the first flange, the insulating layer sleeves the first sleeve portion and one of the fourth waterproof rings, and the second backing ring and the other fourth waterproof ring sleeve the first sleeve portion to be located outside the insulating layer.

In some embodiments, the second water jacket further includes a second upper top surface and a second lower bottom surface, the second water jacket is tapered from the second lower bottom surface to the second upper top surface, and the second upper top surface and the second lower bottom surface are arc-shaped.

In some embodiments, the fourth communication space is larger than the third communication space.

The detailed features and advantages of the present invention are described in detail in embodiments, and the contents are sufficient to those familiar with the relevant skills to understand the technical content of the present invention and implement it correspondingly, and according to the contents disclosed in this specification, the scope of the patent application and the drawings, any person familiar with the relevant skills can easily understand the relevant purposes and advantages of the present invention.

### BRIEF DESCRIPTION OF THE DRAWINGS

FIG. 1 is an explosion diagram of a gun connector according to some embodiments;

FIG. 2 is a cross-sectional view of a gun connector according to some embodiments;

FIG. 3 is a cross-sectional view of a liquid cooled cable according to some embodiments;

FIG. 4 is a schematic diagram of an appearance of a charging device according to some embodiments;

FIG. 5 is a side view of a gun connector from a direction of a first terminal portion according to some embodiments;

FIG. 6 is a block diagram of a charging pile according to some embodiments;

FIG. 7 is a schematic diagram of a charging device and flowing of cooling liquid according to some embodiments;

FIG. 8 is an explosion diagram of a pile connector according to some embodiments;

FIG. 9 is a cross-sectional view of a pile connector according to some embodiments and

FIG. 10 is a side view of a pile connector from a direction of a second terminal portion according to some embodiments.

### DETAILED DESCRIPTION

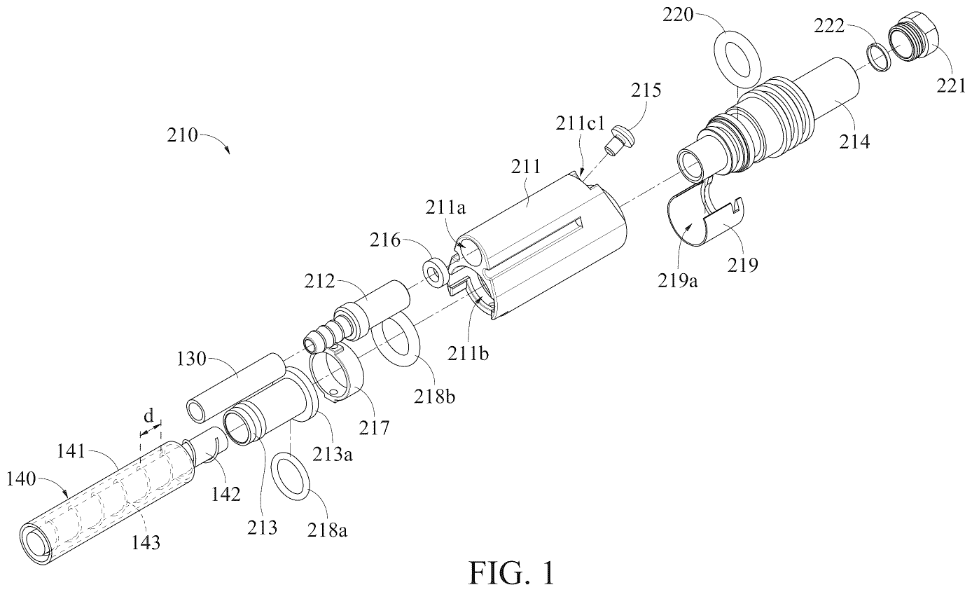

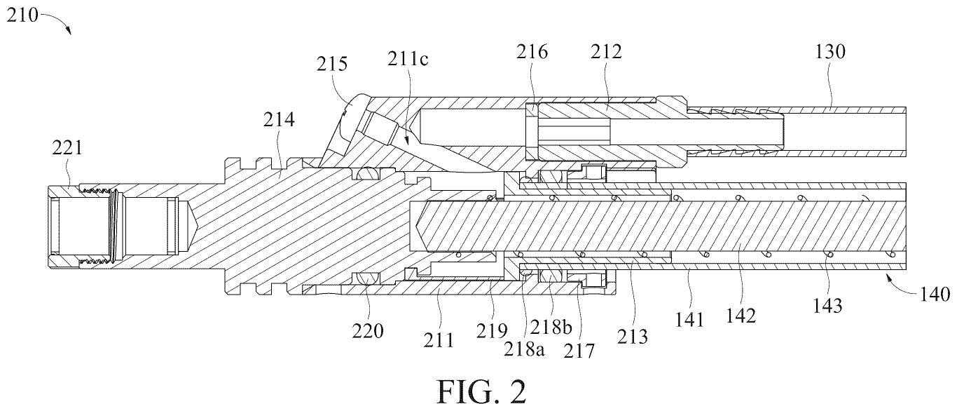

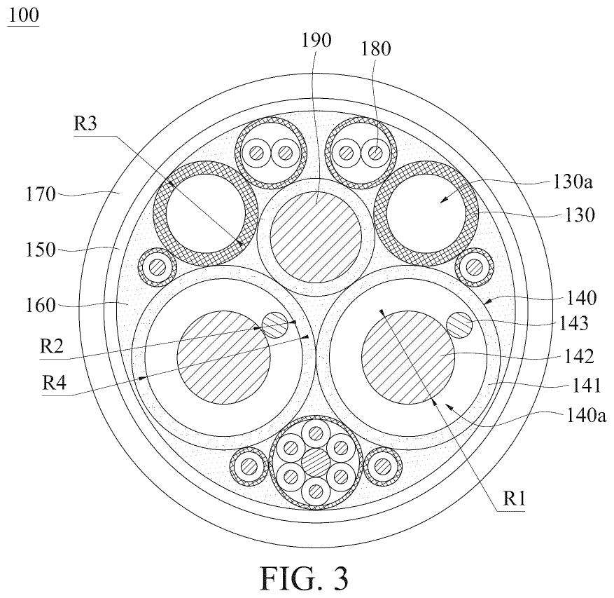

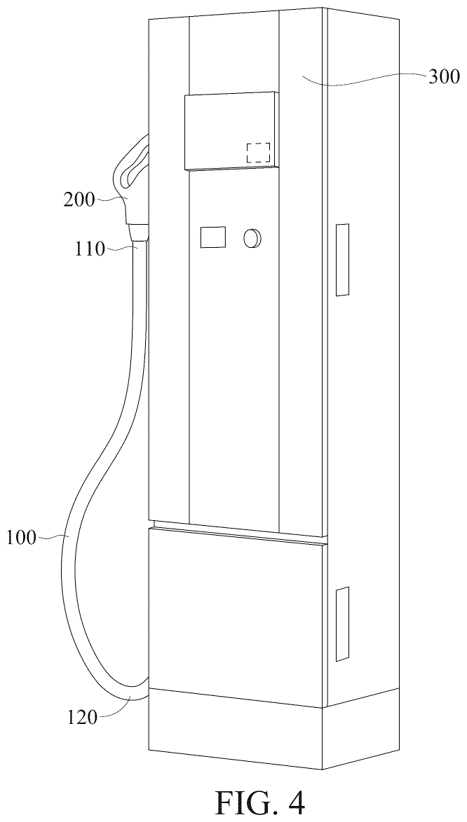

Referring to FIG. 1 to FIG. 4, FIG. 1 is an explosion diagram of a gun connector according to some embodiments. FIG. 2 is a cross-sectional view of a gun connector according to some embodiments. FIG. 3 is a cross-sectional view of a liquid cooled cable according to some embodiments. FIG. 4 is a schematic diagram of an appearance of a charging device according to some embodiments. A liquid cooled cable assembly includes a liquid cooled cable 100 and a charging gun 200.

Referring to FIG. 3 and FIG. 4, the liquid cooled cable 100 has a gun end 110 and a pile end 120. Based on this, the liquid cooled cable 100 includes a first insulating tube 130, a second insulating tube 140, a taping 150, a line body 160, and a covering body 170.

The first insulating tube 130 has a first channel 130a. The first insulating tube 130 is a return tube which may be made of a waterproof material such as PP. Correspondingly, the second insulating tube 140 is a liquid inlet tube. In some embodiments, the first insulating tube 130 may also be made of a solvent-resistant material such as TPE, XLPE, XLPO, and Nylon. Since first insulating tube 130 has the first channel 130a, liquid such as cooling liquid can flow in the first insulating tube 130. In an embodiment, the cooling liquid such as but not limited to esters has the characteristics of insulation, non-conduction, and heat dissipation effect. Moreover, the esters cannot react with the first insulating tube 130, the second insulating tube 140, or other conductors. In some embodiments, the first insulating tube 130 is a liquid inlet tube. Correspondingly, the second insulating tube 140 is a return tube.

The second insulating tube 140 includes an insulating layer 141, a second channel 140a, a power conductor 142, and a spacer 143. In some embodiments, the second insulating tube 140 is a liquid inlet tube which can be made of a thermosetting polymer material such as XLPE, XLPO, and EPR. Since the second channel 140a is located in the insulating layer 141, the liquid such as the cooling liquid can flow in the second insulating tube 140. The power conductor 142 is located in the second channel 140a.

In some embodiments, the power conductor 142 may be formed by a copper stranded wire. The copper stranded wire may be single stranded or multi-stranded. The single wire diameter is preferably 0.18-0.3 mm (such as 0.2 mm, 0.25 mm and 0.27 mm). The square number of the power conductor is preferably 16 mm² to 50 mm² (such as 20 mm², 30 mm², and 40 mm²). The outer diameter of the power conductor is preferably 6-10 mm (such as 7 mm, 8 mm, and 9 mm). Therefore, under this value, the power conductor 142 not only can improve the current load capacity, but also can improve the flexibility and prolong the service life.

The spacer 143 is disposed around the power conductor 142 to space the power conductor 142 from the insulating layer 141. In some embodiments, the spacer 143 is made of a solvent-resistant material such as TPE, XLPE, XLPO, Nylon, or a combination of a flexible and easily-shaped non-conductive material and the polymer material. In some other embodiments, the spacer 143 is made of a non-conductive material or a low-thermal-conductivity material. Based on this, when the spacer 143 is disposed around the power conductor 142 and is located between the power conductor 142 and the insulating layer 141, the electricity or heat of the power conductor 142 can be isolated from being conducted to the insulating layer 141. In some embodiments, the spacer 143 is disposed around the power conductor 142 in a winding mode. Further, the spacer 143 is disposed in a winding mode along the outer diameter of the power conductor 142. In some embodiments, as shown in FIG. 1, if a lay d (the distance between every two circles after winding) of the spacer 143 is too short and thereby circles are dense, the flow rate of cooling liquid will be influenced. If the lay d is too large and thereby the circles are fewer, the power conductor 142 may directly touch the insulating layer 141 when the liquid cooled cable 100 is bent. In an embodiment, the lay d of the spacer 143 ranges from 15 mm to 35 mm, for example, 20 mm, 25 mm, or 30 mm. Therefore, within such range, the power conductor 142 can be prevented from directly touching the insulating layer 141 when the liquid cooled cable 100 is bent.

In some embodiments, the heat deflection temperature (HDT) of the spacer 143 is higher than that of the insulating layer 141. Based on this, the spacer 143 and the insulating layer 141 are prevented from being melted by the high temperature of the power conductor 142 during charging to cause leakage of the cooling liquid. The spacer 143 is made of a thermosetting polymer material such as XLPE, XLPO, and EPR.

Moreover, the spacer 143 can isolate the power conductor 142 from being in direct contact with the insulating layer 141. Moreover, since the spacer 143 is made of an insulating material, the heat-conducting property is low. In the presence of the cooling liquid, because the spacer 143 is in direct contact with the power conductor 142, it needs to be made of a material with high HDT, and the insulating layer 141 can be made of a material with low HDT.

In some embodiments, the liquid cooled cable 100 includes two first insulating tubes 130 and two second insulating tubes 140. When there are a positive electrode and a negative electrode in the charging device, one first insulating tube 130 and one second insulating tube 140 correspond to the positive electrode. The other first insulating tube 130 and the other second insulating tube 140 correspond to the negative electrode.

The taping 150 wraps the first insulating tube 130 and the second insulating tube 140. In some embodiments, the taping 150 is made of a non-woven fabric material, is used for preliminarily fixing a line in the liquid cooled cable 100 and maintaining the shape and then is wrapped with the covering body 170 (detailed later). In some other embodiments, the taping 150 wraps the line body 160 (detailed later). Based on this, the taping 150 can further wrap the line body 160 to shape the line body 160. Further, the line body 160 can be wrapped by the taping 150, so that the whole line body is prevented from being loosened.

The line body 160 is located in the taping 150 and filled between the first insulating tube 130 and the second insulating tube 140. The covering body 170 covers the taping 150. In some embodiments, the line body 160 is, for example but not limited to, a PP taping, which is filled in the taping 150 and fully fills a space formed in the taping 150. Based on this, the line body 160 is distributed around the first insulating tube 130 and the second insulating tube 140. In addition, through the filling of the line body 160, when the first insulating tube 130 and the second insulating tube 140 are wrapped with the covering body 170 (or the taping 150), the first insulating tube 130 and the second insulating tube 140 will not shake randomly in the covering body 170 (or the taping 150) due to the filling of the line body 160. In some embodiments, the covering body 170 is made of a material such as but not limited to CR, TPU, LSHF, and TPE.

In some embodiments, the liquid cooled cable 100 further includes a signal line 180 which can be used for transmitting electric signals. In some embodiments, the signal line 180 is formed by a conductor (for example, a copper wire) or an optical fiber. For example, the signal line 180 may be formed by weaving the conductor, an insulator, and a tinned copper mesh in sequence from inside to outside. In some embodiments, 14 signal lines 180 are provided, among which 6 signal lines 180 may be additionally bundled into a whole by the insulator (as shown in FIG. 3, the signal lines 180 at the lower portion). In addition, 2 signal lines 180 may be bundled into a whole by the insulator (as shown in FIG. 3, the signal lines 180 at the upper portion).

In some other embodiments, the liquid cooled cable 100 further includes a ground line 190 which may be formed by the conductor (such as a copper wire), and is covered with the insulator on the outermost layer. The insulator is made of a material such as, but not limited to, PE, XLPE, EPR, PVC, and XLPO. Based on this, the line body 160 is located in the taping 150 and filled between the signal line 180 and the ground line 190. Further, as for the first insulating tube 130, the second insulating tube 140, the signal lines 180, and the ground line 190, due to the filling of the line body 160, the first insulating tube 130, the second insulating tube 140, the signal lines 180, and the ground line 190 will not shake randomly in the covering body 170 (or the taping 150).

According to the voltage and current requirements, the power conductor 142 ranges from 16 mm² to 70 mm². In order to achieve a good heat dissipation effect, a cooling pipeline also needs to be changed correspondingly. When the outer diameter of the power conductor 142 is R₁, the outer diameter of a spacer 143 is R₂, the inner diameter of the first insulating tube 130 is R₃, and the inner diameter of the second insulating tube 140 is R₄. The optimal cooling effect can be achieved in the following relational expression:

[R₄−(R₁+2R₂)]/2=0.5−0.8.

(R₄²−R₁²−R₂²)π/4 =70−100.

In some embodiments, the outer diameter R₁ of the power conductor 142 preferably ranges from 6 mm to 11.9 mm. The outer diameter R₂ of the spacer 143 preferably ranges from 1.4 mm to 2.3 mm. The inner diameter R₃ of the first insulating tube 130 preferably ranges from 6 mm to 8 mm. The inner diameter of the second insulating tube 140 preferably ranges from 12 mm to 16 mm.

Referring to FIG. 1, FIG. 2 and FIG. 4, the charging gun 200 includes a gun connector 210 which is connected to a gun end 110. The gun connector 210 includes a first water jacket 211, a first connector portion 212, a first sleeve portion 213, and a first terminal portion 214.

The first water jacket 211 includes a first communication space 211a, a second communication space 211b, and a gun connected channel 211c (shown in FIG. 2). The gun connected channel 211c communicates the first communication space 211a with the second communication space 211b. In some embodiments, the gun connected channel 211c is obliquely connected to the first communication space 211a and the second communication space 211b at an oblique angle. In some embodiments, the water jacket is a space for a cooling medium to exchange heat, and the cooling liquid is but not limited to water or liquid. Further, the water jacket can be used for accommodating the cooling medium. The cooling medium circularly flows to effectively absorb and dissipate heat, and therefore devices or apparatuses are prevented from overheating, and normal operation and performance of the devices or the apparatuses can be protected.

In an embodiment, the first communication space 211a and the second communication space 211b are approximately two spaces parallel to each other. The gun connected channel 211c obliquely penetrates through the first communication space 211a and the second communication space 211b. Based on this, the gun connected channel 211c forms an oblique angle with the first communication space 211a and the second communication space 211b. Moreover, because the gun connected channel 211c penetrates through the first communication space 211a and the second communication space 211b, the first communication space 211a can be communicated with the second communication space 211b through the gun connected channel 211c.

In some embodiments, the gun connected channel 211c is formed by CNC drilling. Based on this, the gun connector 210 further includes a first sealing piece 215. The gun connected channel 211c further includes a first opening 211c1. The first opening 211c1 is sealed through the first sealing piece 215. Therefore, cooling liquid flowing in the first water jacket 211 cannot leak through the first opening 211c1.

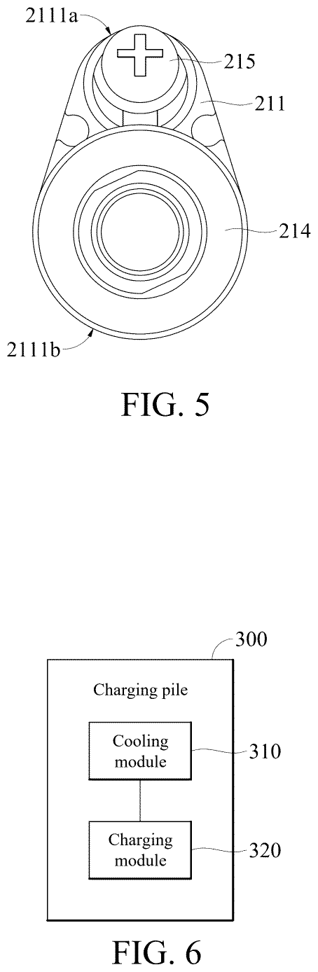

Referring to FIG. 5, FIG. 5 is a side view of a gun connector from a direction of a first terminal portion according to some embodiments. In some embodiments, the first water jacket 211 further includes a first upper top surface 2111a and a first lower bottom surface 2111b. The first water jacket 211 is tapered from the first lower bottom surface 2111b to the first upper top surface 2111a, and the first upper top surface 2111a and the first lower bottom surface 2111b are arc-shaped. Based on this, the second communication space 211b is larger than the first communication space 211a, so that the cooling liquid flowing in the second communication space 211b is more than the cooling liquid flowing in the first communication space 211a, and a better heat dissipation effect is achieved on the power conductor 142 (detailed later).

Further, the first upper top surface 2111a is arc-shaped, so if the gun connected channel 211c is subjected to CNC drilling from the first upper top surface 2111a, it is difficult to seal the formed opening. Therefore, the gun connected channel 211c is subjected to CNC drilling laterally performed on a plane adjacent to the first upper top surface 2111a; and the first opening 211c1 is formed on the plane, so when the first sealing piece 215 is used for sealing the first opening 211c1, the sealing effect is achieved more easily.

The first connector portion 212 is connected to the first water jacket 211 to communicate with the first communication space 211a. The first insulating tube 130 sleeves the first connector portion 212 to enable the first channel 130a to communicate with the first communication space 211a. The first connector portion 212 is preferably a hollow tubing connector, with one end connected to the first water jacket 211, and the other end sleeving the first insulating tube 130. Based on this, the first channel 130a can be communicated with the first communication space 211a through the first connector portion 212.

In some embodiments, the gun connector 210 further includes a first waterproof ring pad 216 which is disposed between joined parts of the first connector portion 212 and the first water jacket 211. Based on this, through the first waterproof ring pad 216, when the cooling liquid flows through the first channel 130a and the first communication space 211a, the cooling liquid can be prevented from leaking from the joined parts of the first connector portion 212 and the first water jacket 211.

The first sleeve portion 213 is connected to the first water jacket 211 to communicate with the second communication space 211b. The first sleeve portion 213 is preferably a hollow sleeve, with one end of the hollow sleeve connected to the first water jacket 211, and the other end of the hollow sleeve sleeving the second insulating tube 140. Therefore, the second channel 140a can be communicated with the second communication space 211b through the first sleeve portion 213.

In some embodiments, the gun connector 210 further includes a first backing ring 217 and two second waterproof rings (218a and 218b). The first sleeve portion 213 further includes a first flange 213a. One of the second waterproof rings 218a sleeves the first sleeve portion 213 to abut against the first flange 213a. The insulating layer 141 sleeves the first sleeve portion 213 and one of the second waterproof rings 218a. The first backing ring 217 and the other second waterproof ring 218b sleeve the first sleeve portion 213 and are located outside the insulating layer 141. In some embodiments, the second waterproof ring 218a which sleeves the first sleeve portion 213 to abut against the first flange 213a may be an annular gasket.

Further, when the first sleeve portion 213 is connected to the first water jacket 211, the first flange 213a is located in the first water jacket 211. The second insulating tube 140 sleeves the other end of the first sleeve portion 213. Based on this, the power conductor 142 passes through the hollow part of the first sleeve portion 213 and is located in the second communication space 211b, and the insulating layer 141 sleeves an outer side of the first sleeve portion 213.

In order to prevent the cooling liquid from leaking, one of the second waterproof ring 218a sleeves the first sleeve portion 213 to abut against the first flange 213a, and then the insulating layer 141 sleeves the outer side of the first sleeve portion 213 and wraps the second waterproof ring 218a at the same time. The other second waterproof ring 218b then sleeves the first sleeve portion 213 and is located outside the insulating layer 141. The first backing ring 217 also sleeves the first sleeve portion 213 and are located outside the insulating layer 141, and applies pressure to the first flange 213a. Based on this, the first backing ring 217 tightly presses the two second waterproof rings (218a, 218b) to prevent the second waterproof rings (218a, 218b) from falling off, and meanwhile, the cooling liquid is prevented from leaking. In some embodiments, the first backing ring 217 can be locked by a screw and is pressurized and fixed.

The first terminal portion 214 is connected to the first water jacket 211. The second insulating tube 140 sleeves the first sleeve portion 213, and the power conductor 142 is electrically connected to the first terminal portion 214. In some embodiments, the first terminal portion 214 is made of metal or other conductive materials, for example, but not limited to metal. As described above, when the second insulating tube 140 sleeves the first sleeve portion 213, the power conductor 142 passes through the hollow part of the first sleeve portion 213 and are located in the second communication space 211b. Based on this, the power conductor 142 is electrically connected to the first terminal portion 214.

In some embodiments, the gun connector 210 further includes a first C-shaped retaining ring 219 and a first waterproof ring 220. The first C-shaped retaining ring 219 is crimped to the first terminal portion 214 and the power conductor 142. The first waterproof ring 220 sleeves the first terminal portion 214, and an outer side of the first waterproof ring 220 makes contact with the first water jacket 211. When the connected to the first water jacket 211, the first terminal portion 214 is partially located in the first water jacket 211. Based on this, when sleeving the first terminal portion 214, the first waterproof ring 220 is also located in the first water jacket 211. Therefore, the outer diameter of the first waterproof ring 220 will be against the first water jacket 211. Due to the first waterproof ring 220, the cooling liquid in the second communication space 211b can be prevented from leaking.

In addition, the first C-shaped retaining ring 219 is crimped to the first terminal portion 214 and the power conductor 142, so the first terminal portion 214 can be electrically connected to the power conductor 142. Furthermore, the first C-shaped retaining ring 219 includes a first gap 219a. Therefore, the cooling liquid can flow into the first communication space 211a through the first gap 219a.

In some embodiments, the gun connector 210 further includes a first replacement cap 221 which is detachably disposed on the first terminal portion 214. Based on this, the first replacement cap 221 is disposed on the first terminal portion 214 and located outside the first water jacket 211 in a manner, for example, but not limited to by threaded locking. For some other embodiments, when the first replacement cap 221 is disposed on the first terminal portion 214, a reed 222 can be further disposed for providing shock absorption and buffering and increasing electric conduction and contact. Based on this, when the first terminal portion 214 fails, it is only needed to replace the first replacement cap 221, rather than replacing the whole first terminal portion 214.

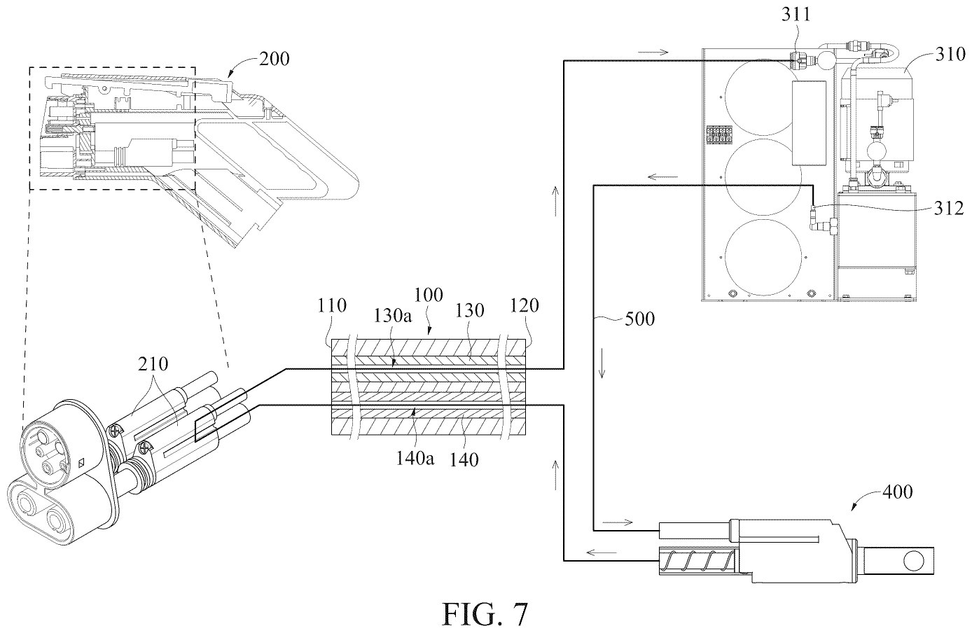

Referring to FIG. 4, FIG. 6 and FIG. 7, FIG. 6 is a block diagram of a charging pile according to some embodiments. FIG. 7 is a schematic diagram of a charging device and flowing of cooling liquid according to some embodiments. The charging device includes the above-mentioned liquid cooled cable assembly (a liquid cooled cable 100 and a charging gun 200), a charging pile 300, a communication tube 500, and a pile connector 400. In an embodiment, as shown in FIG. 7, the arrow represents the flowing direction of the cooling liquid. Connecting lines between all the elements represent pipeline connection. For example, the communication tube 500 is connected between a cooling module 310 and the pile connector 400, or the liquid cooled cable 100 is connected to the charging gun 200.

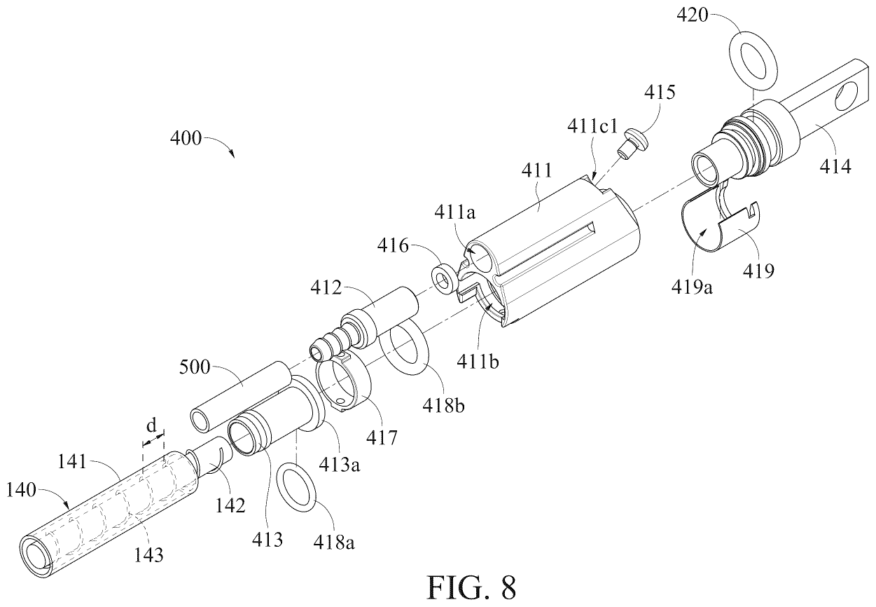

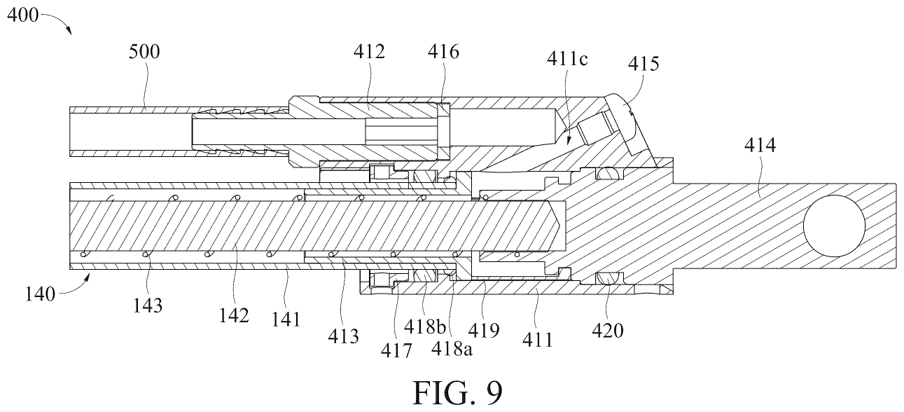

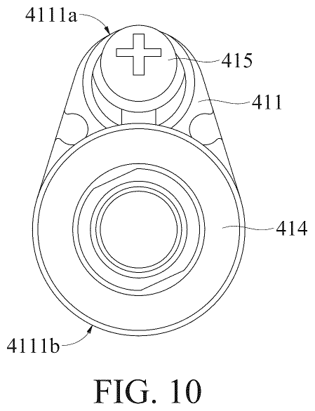

Referring to FIG. 8, FIG. 9 and FIG. 10, FIG. 8 is an explosion diagram of a pile connector according to some embodiments. FIG. 9 is a cross-sectional view of a pile connector according to some embodiments. FIG. 10 is a side view of a pile connector from a direction of a second terminal portion according to some embodiments.

The charging pile 300 includes the cooling module 310 and a charging module 320. The charging module 320 is electrically connected to the cooling module 310 for providing a power source. The cooling module 310 includes a water inlet 311 and a water outlet 312. The water inlet 311 is connected to the pile end 120 of the liquid cooled cable 100 and connects the first channel 130a. That is, the water inlet 311 is connected to the first insulating tube 130. Two ends of the communication tube 500 are connected to the pile connector 400 and the water outlet 312 of the cooling module 310, respectively.

The pile connector 400 (second terminal portion 414) is electrically connected to the charging module 320. The pile connector 400 includes a second water jacket 411, a second connector portion 412, a second sleeve portion 413, and the second terminal portion 414.

The second water jacket 411 includes a third communication space 411a, a fourth communication space 411b, and a pile connected channel 411c (shown in FIG. 9). The pile connected channel 411c communicates the third communication space 411a with the fourth communication space 411b. In some embodiments, the pile connected channel 411c is obliquely connected to the third communication space 411a and the fourth communication space 411b at an oblique angle. As described above, in some embodiments, the water jacket is a space for a cooling medium to exchange heat, and the cooling medium is but not limited to water or liquid. Further, the water jacket can be used for accommodating the cooling medium. The cooling medium circularly flows to effectively absorb and dissipate heat, and therefore devices or apparatuses are prevented from overheating, and normal operation and performance of the devices or the apparatuses can be protected.

In an embodiment, the third communication space 411a and the fourth communication space 411b are approximately two spaces which are parallel to each other. The pile connected channel 411c obliquely penetrates through the third communication space 411a and the fourth communication space 411b. Based on this, the pile connected channel 411c forms an oblique angle relative to the third communication space 411a and the fourth communication space 411b. Moreover, the pile connected channel 411c penetrates through the third communication space 411a and the fourth communication space 411b, so that the third communication space 411a can communicate with the fourth communication space 411b through the pile connected channel 411c.

In some embodiments, the pile connected channel 411c is formed by CNC drilling. The pile connector 400 further includes a second sealing piece 415. The pile connected channel 411c further includes a second opening 411c1. The second opening 411c1 is sealed through the second sealing piece 415. Based on this, cooling liquid flowing in the second water jacket 411 is prevented from leaking through the second opening 411c1.

Referring to FIG. 10, in some embodiments, the second water jacket 411 includes a second upper top surface 4111a and a second lower bottom surface 4111b. The second water jacket 411 is tapered from the second lower bottom surface 4111b to the second upper top surface 4111a, and the second upper top surface 4111a and the second lower bottom surface 4111b are arc-shaped. Based on this, the fourth communication space 411b is larger than a third communication space 411a, so the cooling liquid flowing in the fourth communication space 411b is more than the cooling liquid flowing in the third communication space 411a, and a better heat dissipation effect on the power conductor 142 is achieved.

Further, since the second upper top surface 4111a is arc-shaped, if the pile connected channel 411c is subjected to CNC drilling from the second upper top surface 4111a, it is difficult to seal the formed opening. Therefore, the pile connected channel 411c is subjected to CNC drilling laterally from a plane adjacent to the second upper top surface 4111a. Based on this, since the second opening 411c1 is formed in the plane, when the second sealing piece 415 seals the second opening 411c1, the sealing effect is achieved more easily.

The second connector portion 412 is connected to the second water jacket 411 to communicate with the third communication space 411a. The other end of the communication tube 500 sleeves the second connector portion 412. The second connector portion 412 is preferably a hollow tubing connector, with one end connected to the second water jacket 411, and the other end sleeving the communication tube 500.

In some embodiments, the pile connector 400 further includes a second waterproof ring pad 416 which is disposed between joined parts of the second connector portion 412 and the second water jacket 411. Based on this, through the second waterproof ring pad 416, when the cooling liquid flows through the communication tube 500 and the third communication space 411a, the cooling liquid can be prevented from leaking from the joined parts of the second connector portion 412 and the second water jacket 411.

The second sleeve portion 413 is connected to the second water jacket 411 to communicate with the fourth communication space 411b. The second sleeve portion 413 is preferably a hollow sleeve, with one end connected to the second water jacket 411, and the other end sleeving the second insulating tube 140. Based on this, the second channel 140a can be communicated with the fourth communication space 411b through the second sleeve portion 413.

In some embodiments, the pile connector 400 further includes a second backing ring 417 and two fourth waterproof rings (418a, 418b). The second sleeve portion 413 further includes a second flange 413a. One of the fourth waterproof rings 418a sleeves the second sleeve portion 413 to abut against the second flange 413a. The insulating layer 141 sleeves the second sleeve portion 413 and one of the fourth waterproof ring 418a. The second backing ring 417 and the fourth waterproof ring 418b sleeve the second sleeve portion 413 and are located outside the insulating layer 141. In some embodiments, the fourth waterproof ring 418a which sleeves the second sleeve portion 413 to abut against the second flange 413a may be an annular gasket.

Further, when the second sleeve portion 413 is connected to the second water jacket 411, the second flange 413a is located in the second water jacket 411. The second insulating tube 140 sleeves the other end of the second sleeve portion 413. Therefore, the power conductor 142 passes through the hollow part of the second sleeve portion 413 and is located in the fourth communication space 411b, and the insulating layer 141 sleeves an outer side of the second sleeve portion 413.

In order to prevent cooling liquid from leaking, the fourth waterproof ring 418a sleeves the second sleeve portion 413 to abut against the second flange 413a, and the insulating layer 141 sleeves the outer side of the second sleeve portion 413 and wraps the fourth waterproof ring 418a. Then the fourth waterproof ring 418b sleeves the second sleeve portion 413 and are located outside the insulating layer 141. The second backing ring 417 sleeves the second sleeve portion 413 and are located outside the insulating layer 141, and applies pressure to the second flange 413a. Based on this, the second backing ring 417 tightly presses the two fourth waterproof rings (418a, 418b) to prevent the fourth waterproof rings (418a, 418b) from falling off, and meanwhile, the cooling liquid is prevented from leaking. In some embodiments, the second backing ring 417 can be locked by a screw and is pressurized and fixed.

The second terminal portion 414 is connected to the second water jacket 411. The second insulating tube 140 sleeves the second sleeve portion 413, and the power conductor 142 is electrically connected to the second terminal portion 414. In some embodiments, the second terminal portion 414 is made of metal or other conductive materials, for example, but not limited to metal. As described above, when the second insulating tube 140 sleeves the second sleeve portion 413, the power conductor 142 passes through a hollow part of the second sleeve portion 413 and is located in the fourth communication space 411b. The power conductor 142 is electrically connected to the second terminal portion 414.

In some embodiments, the pile connector 400 further includes a second C-shaped retaining ring 419 and a third waterproof ring 420. The second C-shaped retaining ring 419 is crimped to the second terminal portion 414 and the power conductor 142. The third waterproof ring 420 sleeves the second terminal portion 414, and an outer side of the third waterproof ring 420 makes contact with the second water jacket 411. When connected to the second water jacket 411, the second terminal portion 414 is partially located in the second water jacket 411. Based on this, when sleeving the second terminal portion 414, the third waterproof ring 420 is also located in the second water jacket 411. Therefore, the outer diameter of the third waterproof ring 420 will be against the second water jacket 411. Due to the third waterproof ring 420, the cooling liquid in the fourth communication space 411b can be prevented from leaking.

Moreover, the second C-shaped retaining ring 419 is crimped to the second terminal portion 414 and the power conductor 142, so the second terminal portion 414 can be electrically connected to the power conductor 142. Furthermore, the second C-shaped retaining ring 419 includes a second gap 419a. Therefore, when the cooling liquid is about to flow to the fourth communication space 411b from the third communication space 411a, the cooling liquid can flow into the fourth communication space 411b through the second gap 419a.

Referring to FIG. 7, after the cooling liquid flows out through the water outlet 312 of the cooling module 310, the cooling liquid flows into the third communication space 411a of the pile connector 400 through the communication tube 500. After flowing into the fourth communication space 411b, the cooling liquid flows to the second insulating tube 140, and then flows into the second communication space 211b of the gun connector 210. After flowing to the first communication space 211a, the cooling liquid flows into the first insulating tube 130 and then flows back to the cooling module 310. Based on this, the whole circulation process is finished, and the gun connector 210, the pile connector 400, and the liquid cooled cable 100 are cooled at the same time.

In conclusion, in some embodiments, the gun connector and the pile connector according to the embodiments of the present invention both include the communication spaces and oblique connected channels, so that the cooling liquid can flow in the gun connector and the pile connector to cool the gun connector and the pile connector. Moreover, the liquid cooled cable takes the power conductor as the conductor, the space capable of accommodating the cooling liquid is formed in the second insulating tube, and thereby the cooling liquid make full contact with the power conductor to achieve the optimal cooling effect. In addition, the spacer is disposed around the power conductor and located between the power conductor and the insulating layer, it can isolate the electrical or thermal conduction of the power conductor to the insulating layer. The problem of overheating of the devices in the charging process in related technology is solved. Moreover, the problem of overheating of the cable and its connected end due to charging is also solved.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A liquid cooled cable assembly, comprising:
a liquid cooled cable, having a gun end and a pile end, comprising:
a first insulating tube, having a first channel;
a second insulating tube, comprising:
an insulating layer;
a second channel, located in the insulating layer;
a power conductor, located in the second channel; and
a spacer, disposed around the power conductor to space the power conductor from the insulating layer;
a taping, wrapping the first insulating tube and the second insulating tube;
a line body, located inside the taping and filled between the first insulating tube and the second insulating tube; and
a covering body, wrapping the taping; and
a charging gun, comprising a gun connector that is connected to the gun end, the gun connector comprising:
a first water jacket, comprising a first communication space, a second communication space, and a gun connected channel, wherein the gun connected channel connects the first communication space with the second communication space;
a first connector portion, connected to the first water jacket to communicate with the first communication space, wherein the first insulating tube sleeves the first connector portion to communicate the first channel with the first communication space;
a first sleeve portion, connected to the first water jacket to communicate the second communication space; and
a first terminal portion, connected to the first water jacket, wherein the second insulating tube sleeves the first sleeve portion, and the power conductor is electrically connected to the first terminal portion.

2. The liquid cooled cable assembly according to claim 1, wherein the gun connected channel is obliquely connected to the first communication space and the second communication space at an oblique angle.

3. The liquid cooled cable assembly according to claim 1, wherein the gun connector further comprises a first sealing piece, the gun connected channel further comprises a first opening, and the first opening is sealed through the first sealing piece.

4. The liquid cooled cable assembly according to claim 1, wherein the gun connector further comprises a first waterproof ring pad which is disposed between joined parts of the first connector portion and the first water jacket.

5. The liquid cooled cable assembly according to claim 1, wherein the gun connector further comprises a first C-shaped retaining ring and a first waterproof ring, the first C-shaped retaining ring is crimped to the first terminal portion and the power conductor, the first waterproof ring sleeves the first terminal portion, and an outer side of the first waterproof ring makes contact with the first water jacket.

6. The liquid cooled cable assembly according to claim 1, wherein the gun connector further comprises a first backing ring and two second waterproof rings, the first sleeve portion further comprises a first flange, one of the second waterproof rings sleeves the first sleeve portion to abut against the first flange, and the insulating layer sleeves the first sleeve portion and one of the second waterproof rings, the first backing ring and the other second waterproof ring sleeve the first sleeve portion and are located outside the insulating layer.

7. The liquid cooled cable assembly according to claim 1, wherein the first water jacket further comprises a first upper top surface and a first lower bottom surface, the first water jacket is tapered from the first lower bottom surface to the first upper top surface, and the first upper top surface and the first lower bottom surface are arc-shaped.

8. The liquid cooled cable assembly according to claim 1, wherein the second communication space is larger than the first communication space.

9. The liquid cooled cable assembly according to claim 1, wherein the gun connector further comprises a first replacement cap which is detachably disposed on the first terminal portion.

10. The liquid cooled cable assembly according to claim 1, wherein the spacer is made of an insulating material, and the heat deflection temperature of the spacer is higher than that of the insulating layer.

11. The liquid cooled cable assembly according to claim 1, wherein a lay of the spacer ranges from 15 mm to 25 mm.

12. The liquid cooled cable assembly according to claim 1, wherein the power conductor has an outer diameter R₁, the spacer has an outer diameter R₂, the second insulating tube has an inner diameter R₄, and R₁, R₂ and R₄ meet a relational expression R₄−(R₁+2R₂)/0.5−0.8.

13. The liquid cooled cable assembly according to claim 1, wherein the power conductor has an outer diameter R₁, the spacer has an outer diameter R₂, the second insulating tube has an inner diameter R₄, and R₁, R₂ and R₄ meet a relational expression (R₄²−R₁²−R₂²)π/4=70−100.

14. A charging device, comprising:
the liquid cooled cable assembly according to claim 1;
a charging pile, comprising:
a cooling module, comprising a water outlet and a water inlet, wherein the water inlet is connected to a pile end of the liquid cooled cable and communicated with a first channel; and
a charging module, electrically connected to the cooling module;
a communication tube, having one end communicated with the water outlet; and
a pile connector, electrically connected to the charging module and comprising:
a second water jacket, comprising a third communication space, a fourth communication space, and a pile connected channel, wherein the pile connected channel communicates the third communication space with the fourth communication space;
a second connector portion, connected to the second water jacket to communicate with the third communication space, wherein the other end of the communication tube sleeves the second connector portion;
a second sleeve portion, connected to the second water jacket to communicate with the fourth communication space; and
a second terminal portion, connected to the second water jacket, wherein the second insulating tube sleeves the second sleeve portion, and the power conductor is electrically connected to the second terminal portion.

15. The charging device according to claim 14, wherein the pile connected channel is obliquely connected to the third communication space and the fourth communication space at an oblique angle.

16. The charging device according to claim 14, wherein the pile connector further comprises a second sealing piece, the pile connected channel further comprises a second opening, and the second opening is sealed through the second sealing piece.

17. The charging device according to claim 14, wherein the pile connector further comprises a second waterproof ring pad which is disposed between joined parts of the second connector portion and the second water jacket.

18. The charging device according to claim 14, wherein the pile connector further comprises a second C-shaped retaining ring and a third waterproof ring, the second C-shaped retaining ring is crimped to the second terminal portion and the power conductor, the third waterproof ring sleeves the second terminal portion, and an outer side of the third waterproof ring makes contact with the second water jacket.

19. The charging device according to claim 14, wherein the pile connector further comprises a second backing ring and two fourth waterproof rings, the second sleeve portion further comprises a second flange, wherein one of the fourth waterproof rings sleeves the second sleeve portion to abut against the first flange, the insulating layer sleeves the first sleeve portion and one of the fourth waterproof rings, and the second backing ring and the other fourth waterproof ring sleeve the first sleeve portion and are located outside the insulating layer.

20. The charging device according to claim 14, wherein the second water jacket further comprises a second upper top surface and a second lower bottom surface, the second water jacket is tapered from the second lower bottom surface to the second upper top surface, and the second upper top surface and the second lower bottom surface are arc-shaped.

21. The charging device according to claim 14, wherein the fourth communication space is larger than the third communication space.

22. The charging device according to claim 14, wherein a lay of the spacer ranges from 15 mm to 25 mm.

23. The charging device according to claim 14, wherein the power conductor has an outer diameter R₁, the spacer has an outer diameter R₂, the second insulating tube has an inner diameter R₄, and R₁, R₂ and R₄ meet a relational expression R₄−(R₁+2R₂)/0.5−0.8.

24. The charging device according to claim 14, wherein the power conductor has an outer diameter R₁, the spacer has an outer diameter R₂, the second insulating tube has an inner diameter R₄, and R₁, R₂ and R₄ meet a relational expression (R₄²−R₁²−R₂²)π/4=70−100.
